(19) United States
(12) Patent Application Publication
(10) Pub. No.: US 2011/0271444 A1
(43) Pub. Date: Nov. 10, 2011

(54) Inflatable Mattress

(76) Inventor: Nicholas John Stratton Davis, Cardiff (GB)

(21) Appl. No.: 13/144,525

(22) PCT Filed: Jan. 13, 2010
(86) PCT No.: PCT/GB10/00046

§ 371 Date: Jul. 14, 2011

(30) Foreign Application Priority Data
Jan. 15, 2009 (GB) 0900634.7

(51) Int. Cl. A61G 7/10; A47C 27/10; A47C 21/04; A47C 27/08

(52) U.S. Cl. 5/81.1 R

(57) ABSTRACT

Disclosed is an inflatable mattress (10) for use when transferring a patient from one area to another. The mattress has a flexible lowermost layer (15) providing a smooth or plate finished low friction surface of a polymer, for example a polyurethane, PTFE, or a polyamide such as nylon, or a combination of said polymers, for sliding the mattress whilst a patient is lying thereon; and one or more inflatable elements (30) located or locatable above the lowermost layer, the or each element comprising a flexible water vapour permeable material such as extruded polyurethane film. Said elements (30) may be exposed (see FIG. 4).

This invention relates to an inflatable mattress for use in supporting a patient on a surface and, particularly but not exclusively, for use when transferring a patient from one area to another.

Inflatable mattresses are known. Generally, these mattresses include one or more inflatable bladders on which a patient can rest. The bladder or bladders help to prevent pressure ulcer and the like. However, once a patient is lying on the known inflatable mattress it is often difficult to remove them, for example when transferring a patient from a bed to a trolley. The inflatable bladder tends to hug the contours of the patient's body and therefore a lifting and dragging action is required to remove the patient off the inflatable mattress. Such a lifting and dragging action is particularly problematic for patients with acute pressure ulcers, burns, or other conditions, because being moved in that way is painful. Dragging creates friction at the skin surface and shear within the underlying tissue, which in turn exacerbates pressure damage.

Healthcare Associated Infections are often conveyed by touch, and manual handling of patients, particularly where intimate contact is required to remove them from inflatable mattresses, exacerbates this problem. Further, patients themselves can convey the organisms which cause infections onto the surfaces which they are exposed to, such as porters trolleys, X-ray tables and other supporting surfaces.

This invention has come about because the inventor has realised that there is a need to address the above problems.

According to the invention there is provided a mattress for supporting a patient in a generally lying position comprising: a flexible lowermost layer providing a low friction surface for sliding the mattress whilst a patient is lying thereon; one or more inflatable elements located or locatable above the lowermost layer, the or each element comprising a flexible water vapour permeable material.

In an embodiment the mattress further includes an upper layer of water vapour permeable material joined at least at edge portions to the lowermost layer to form a flexible and openable bag into which the or each inflatable element is insertable.

Conveniently the upper layer includes an aperture of a size which allows a patient lying on the mattress to make contact with the or each inflatable element.

Conveniently, the one or more inflatable elements comprise a plurality of inflatable elements each in fluid communication.

Preferably, the inflatable elements are formed from sheet plastics material which is permeable to water vapour when inflated.

More preferably, said sheet plastics is an extruded polyurethane film.

More preferably still, said film is of a thickness which permits the transmission of sufficient water vapour to prevent a build-up of liquid from a perspiring patient lying on the mattress.

In an embodiment, water vapour permeability of the inflatable elements is in the range of about 50 to 400 grams per metre squared per 24 hours, preferably about 100 to 300 grams per metre squared per 24 hours, or more preferably about 200 grams per metre squared per 24 hours.

Suitably, the mattress further includes flexible handles attached to said edge portions.

Optionally, the mattress includes a plurality of straps attached to and spaced about said edge portions for restraining said mattress in use, and/or for restraining a patient in position on the mattress.

Conveniently, the mattress further includes a heater.

Preferably, said heater comprises an electrical resistance located underneath said inflatable elements.

More preferably, said electrical resistance may be a plurality of electrical conductors formed into a flexible mat inserted between the inflatable cells and the lowermost layer.

More preferably still, said electrical conductors may include carbon.

In an embodiment a said lowermost layer includes a smooth or plate finished low friction polymer, for example a polyurethane, PTFE, or a polyamide such as nylon, or a combination of said polymers.

The invention extends also to any novel feature described herein, or any novel combination of features described herein.

Whilst the invention can be put into effect in many ways, by way of example, one embodiment only is described below, with reference to the drawings, wherein:—

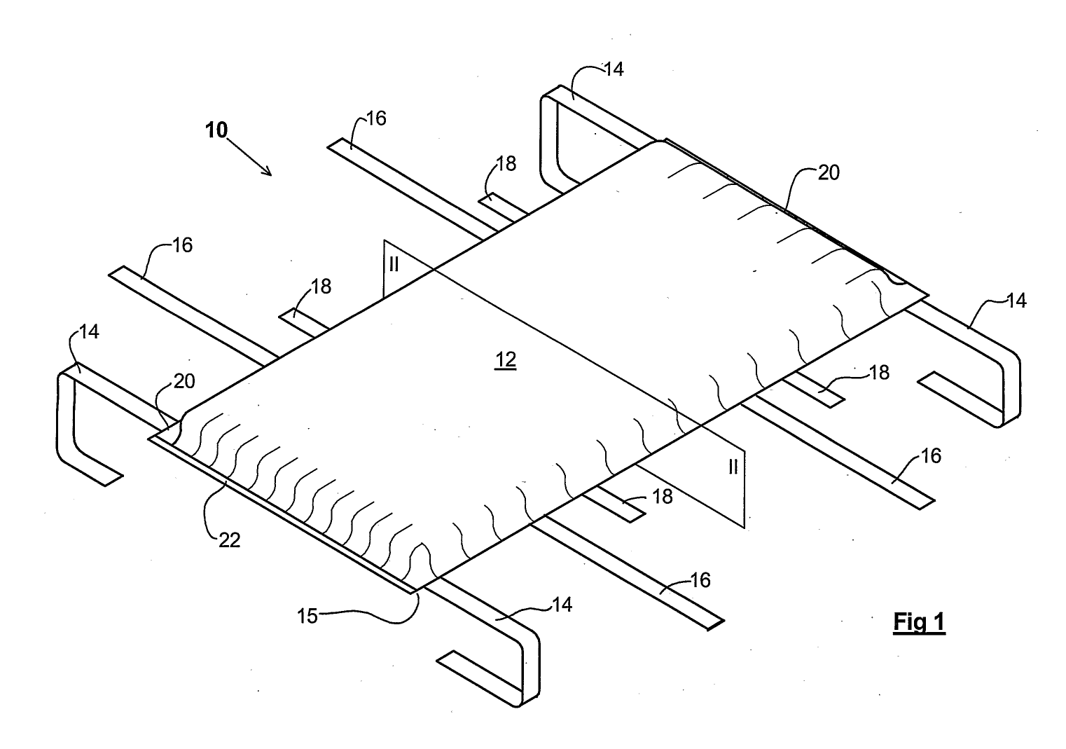

FIG. 1 shows a pictorial view of a first mattress;

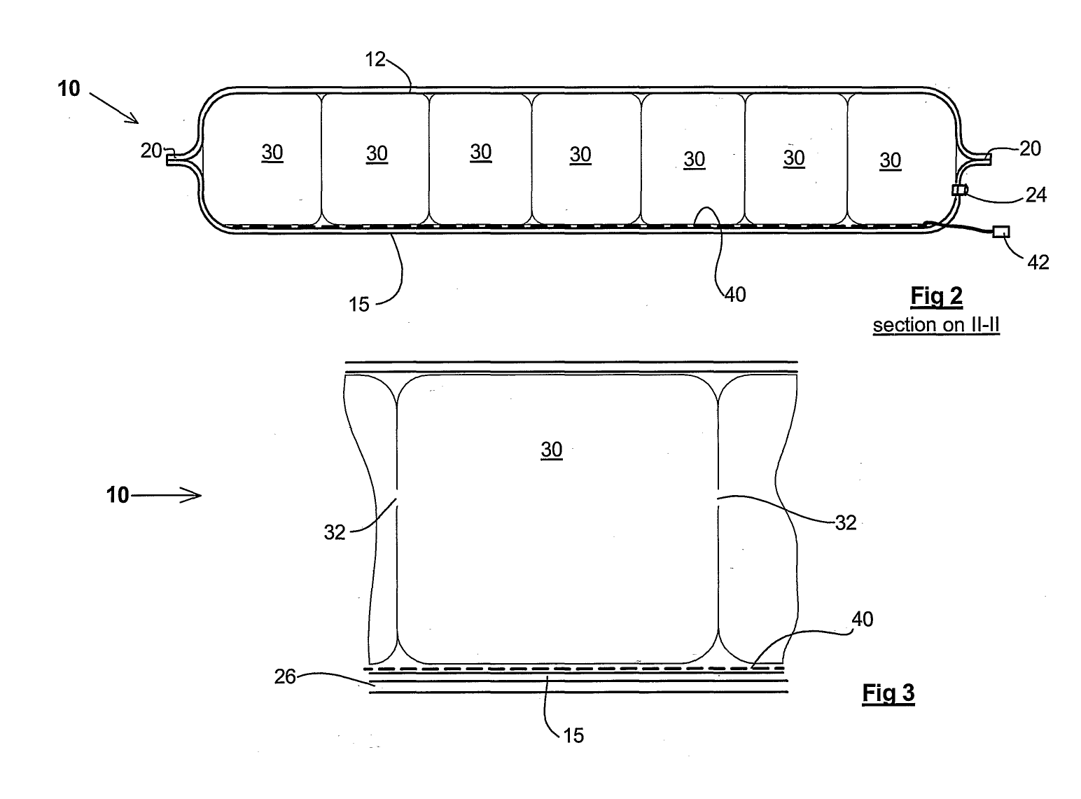

FIG. 2 shows a section through the mattress shown in FIG. 1 in plane

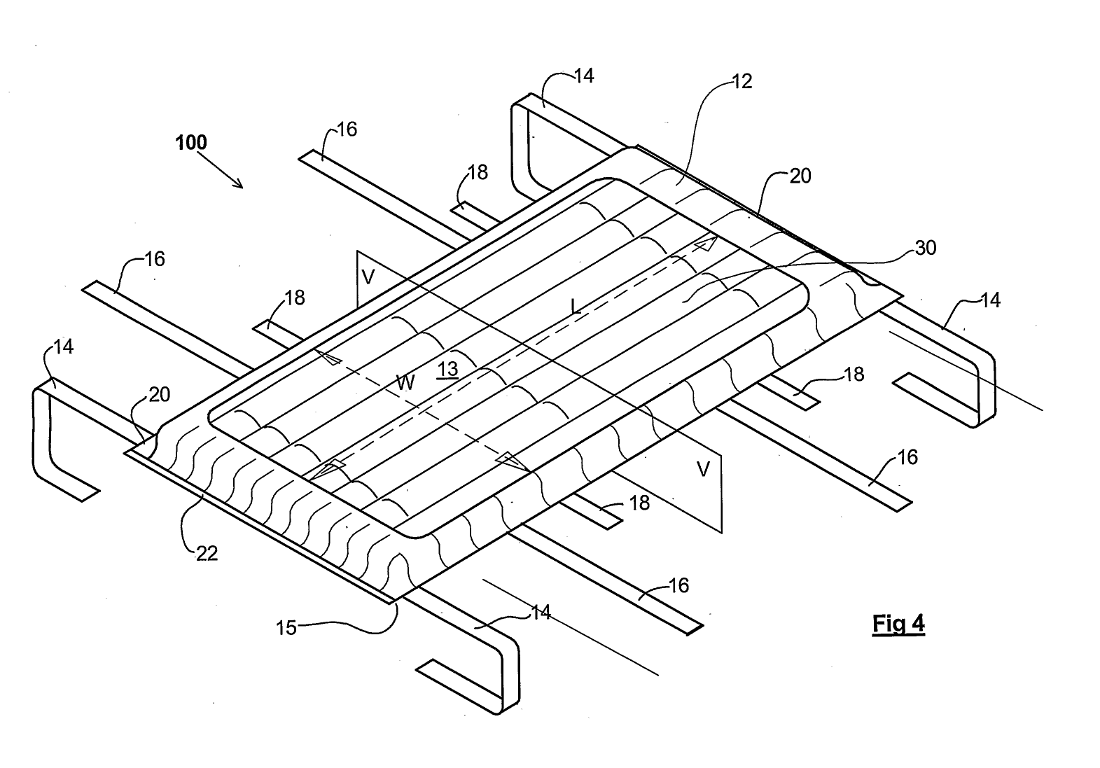

FIG. 3 shows an enlarged view of a portion of the section shown in FIG. 2;

FIG. 4 shows a pictorial view of a second mattress; and

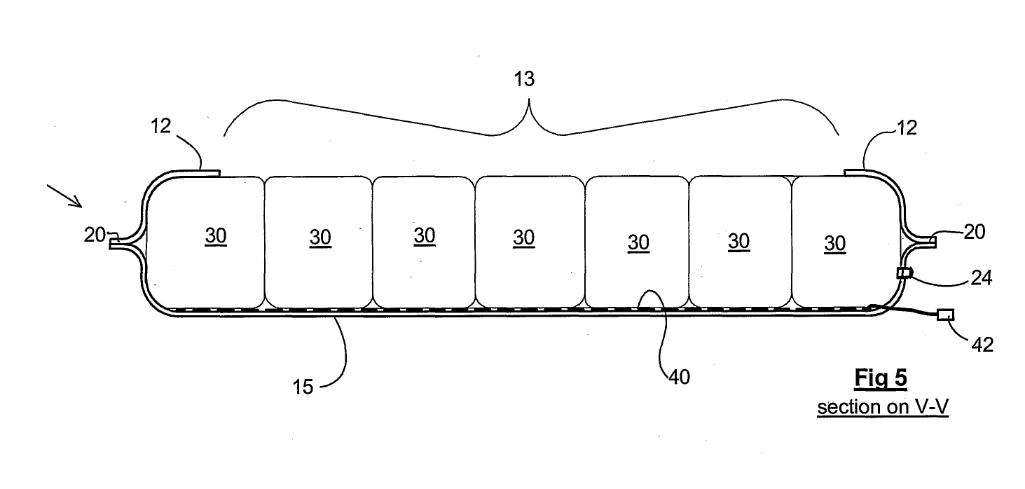

FIG. 5 shows a section through the mattress shown in FIG. 4 in plane V-V;

Referring to FIG. 1 there is shown generally a mattress 10 having in the form of an openable and flexible bag in which inflatable elements can be inserted. The bag has an upper surface 12 on which a patient may lay directly or indirectly. The mattress includes flexible webbing securing straps 14 located at each corner which can be secured together underneath a supporting surface to hold the mattress into position on said surface. The mattress further includes patient restraint straps 16, again made from flexible webbing material, which can be secured together from opposing sides, for example using a hook and burr type fastening, to restrain a patient on the mattress surface 12. Additionally, pull straps 18 are incorporated for manipulating the mattress 10 whilst a patient is lying on it.

The mattress 10 is manufactured from upper 12 and lower 15 sheets of polyurethane coated with nylon, although woven material such as polyester or cotton, impregnated with a polymer such as polyurethane could be used also. This provides a water permeable patient support. The upper and lower sheets are stitched or glued at their edges 20, although one edge seam 22 is openable and closeable, for example using a hook and burr type fastening. When the seam 22 is closed and the inflatable element or elements inflated then the inflatable mattress is ready for use. Prior to that inflation the mattress can be stored un-inflated ready for use and does not take up much storage space.

Referring additionally to FIG. 2 there is shown a cross-section through the plane II-II in FIG. 1. The section shows inflatable elements 30, which in practice are inflatable plastics cells joined together by means of heat welding. These cells are manufactured from a polyurethane film, for example a thermoplastic polyester urethane elastomer film. It has been found that such film having a thickness of 25 mm to 100 mm, preferably 50 to 80 mm, provides a reasonably strong structure having a water vapour transmission rate of about 50-400 grams per metre² per day. Preferably, the water vapour transmission rate should be 100 to 300 grams per metre² per day and ideally about 200 grams per metre² per day.

The inflatable elements thus provide a breathable or vapour permeable material capable of sustaining an inflatable state because the material is substantially impermeable to air. The material transmits water vapour in sufficient amounts to allow a patient's skin to breathe, whilst being sufficiently impermeable to air to allow the inflatable elements to stay inflated for long periods without requiring replenishment.

In order to improve the durability and usability of the inflatable elements, the inflatable elements may be substantially enclosed within the closeable bag formed by the upper layer 12 and a lower most layer 15 joined together at their edges 20.

The inflatable elements 30 can be inflated or deflated via an inlet 24 which includes a sealing stopper. Air in the elements 30 can be heated using a removable and flexible heating pad 40 supplied with electrical current via a plug 42.

Referring additionally to FIG. 3, there is shown an enlarged view of a portion of the mattress shown in FIG. 2. Upper layer 12 is illustrated which provides a water vapour permeable surface. An inflatable element 30, is shown which, as described above is also water vapour permeable, thus, the patient is supported on an inflatable mattress which does not become wet through the perspiration of the patient laying thereon. The inflatable cells 30 are inter-connected by means of passages 32 so that an equalisation of pressure can be obtained in each of the elements thus providing equal support to all body parts. The heating pad 40 is shown located underneath the elements 30 so that a gentle and substantially uniform heat is provided to the patient by means of convection through the air in the elements 30. The heating pad is a polymer mat having polymer elements loaded with carbon to form discrete electrical conductors.

The lowermost layer 15 includes an additionally covering 26, in this case a smooth coating of a PTFE or polyamide polymer formed into a flexible sheet. This lowermost layer provides a surface which can slide over a supporting surface making transfer of a patient, on the mattress reasonably easy, for example when pull straps 16 or 18 are used.

FIG. 4 sows a second embodiment of the invention. In this embodiment a mattress 100 is illustrated which is similar in construction to the mattress 10, and like parts have like reference numerals. This embodiment includes an aperture 13 in the upper layer 12 having a length L and a width W. As can be seen from the drawing the aperture extends across the majority of the area of the upper layer 12. The purpose of the aperture is to allow a patient to lie directly (or indirectly) on the inflatable elements 30, rather than on the upper layer 12. Since the elements 30 can be made from a relatively thin material, then pressure redistribution is enhanced because a softer permeable support can be accomplished.

FIG. 5 sows a section on the plane V-V in FIG. 4. The aperture 13 can be seen clearly in the upper layer 12. The arrangement allows the upper layer 12 and lowermost layer 15 to form a bag to hold the elements 30 in place in use.

The embodiments described above have many advantages over existing mattresses. For example, the inflatable mattresses provide effective pressure redistribution to prevent or inhibit pressure ulcers, whilst allowing the mattress to remain under the patient when the patient is transferred from one surface to another. Thus, the risk of healthcare associated infections is reduced because the patient will not be in direct contact with surfaces other than the mattress. The mattresses can bend, for example at their edges to accommodate supporting surfaces with sides which are narrower than the width of the mattresses. In practice the mattresses will simply bend upwardly and stop the patient from falling off the mattress, when narrow cot sides are used.

In practice, the mattresses can be employed at an early stage in the care of a patient, for example in an ambulance and can be used throughout the journey of care of the patient if necessary. The cushioning effect of the inflatable mattress reduces the pain suffered by the patient during transfer of the patient from one surface to another and will prevent or mitigate further trauma etc when the patient is moved.

The use of the optional warming pad will have the benefit of increasing patient's blood circulation and thereby: reducing the likelihood of pressure ulcers or other pressure damage; reducing the risk of inadvertent hyperthermia, particularly perioperatively; and also reducing the risk of surgical site infection.

Since the whole mattress is flexible it can be deflated and folded for storage when not in use. It is envisaged that the mattress would be employed during a patient's treatment and then cleaned and re-used. The outer cover 12,15 is machine washable and the inflatable elements 30 can be washed with disinfectant, for example a hypochloride solution for safe re-use. If the heating pad 40 is used, then this too can be removed and washed ready for re-use.

1. A mattress for supporting a patient in a generally lying position comprising: a flexible lowermost layer providing a low friction surface for sliding the mattress whilst a patient is lying thereon; one or more inflatable elements located or locatable above the lowermost layer, the or each element comprising a flexible water vapour permeable material.

2. A mattress as claimed in claim 1, wherein mattress further includes an upper layer of water vapour permeable material joined at least at edge portions to the lowermost layer to form a flexible and openable bag into which the or each inflatable element is insertable.

3. A mattress as claimed in claim 2, wherein the upper layer includes an aperture of a size which allows a patient lying on the mattress to make contact with the or each inflatable element.

4. A mattress as claimed in claim 1, wherein the one or more inflatable elements comprise a plurality of inflatable elements each in fluid communication.

5. A mattress as claimed in claim 1, wherein the inflatable element(s) is (are) formed from sheet plastics material which is permeable to water vapour when inflated.

6. A mattress as claimed in 5, wherein said sheet plastics is an extruded polyurethane film.

7. A mattress as claimed in 6, wherein said film is of a thickness which permits the transmission of sufficient water vapour to prevent a build-up of liquid from a perspiring patient lying on the mattress.

8. A mattress as claimed in claim 1, wherein water vapour permeability of the inflatable elements is in the range of about 50 to 400 grams per metre squared per 24 hours, or about 100 to 300 grams per metre squared per 24 hours or about 200 grams per metre squared per 24 hours.

9. A mattress as claimed in claim 5, wherein said sheet plastics material has a thickness of 50 to 80 μm.

10. A mattress as claimed in claim 1, further including flexible handles attached to said edge portions.

11. A mattress as claimed in claim 1, further including a plurality of straps attached to and spaced about said edge portions for restraining said mattress in use, and/or for restraining a patient in position on the mattress.

12. A mattress as claimed in claim 1, further including a heater.

13. A mattress as claimed in claim 12, wherein said heater comprises an electrical resistance located underneath said inflatable element(s).

14. A mattress as claimed in claim 13, wherein said electrical resistance is a plurality of electrical conductors formed into a flexible mat inserted between the inflatable elements and the lowermost layer.

15. A mattress as claimed in claim 14, wherein said electrical conductors include carbon.

16. A mattress as claimed in claim 1, wherein, said lowermost layer includes a smooth or plate finished low friction polymer for example a polyurethane, PTFE, or a polyamide such as nylon, or a combination of said polymers.
